(19) United States
(12) Patent Application Publication
(10) Pub. No.: US 2002/0133564 A1
(43) Pub. Date: Sep. 19, 2002

(54) Apparatus for sending/receiving data and computer program therefor

(76) Inventor: Norihisa Takayama, San Jose, CA (US)

Correspondence Address: Platon N. Mandros, BURNS, DOANE, SWECKER & MATHIS, L.L.P., P.O. Box 1404, Alexandria, VA, 22313-1404, US

(21) Appl. No.: 10/080,708

(22) Filed: Feb. 25, 2002

(30) Foreign Application Priority Data
Mar. 13, 2001 (JP) P2001-070054

(51) Int. Cl. H04N 7/173; G06F 15/16

(52) U.S. Cl. 709/217; 725/105; 709/203

(57) ABSTRACT

An MFP (multi functional peripheral) which sends data via a network is provided with a display controlling section and a list controlling section. Receiving from a data receiving apparatus via the network information representing whether a data receiving apparatus is ready for receiving data, the list controlling section registers the data receiving apparatus that is ready for receiving data in list data and deletes the data receiving apparatus that is not ready for receiving data from registration on the basis of the received information. Further, the display controlling section displays the list data on a display and a sending section accepts selection of destination on the basis of the displayed list data.

This application is based on application No. 2001-070054 filed in Japan, the contents of which are hereby incorporated by reference.

### BACKGROUND OF THE INVENTION

1. Field of the Invention

The present invention relates to a technique for registering a send destination at the time of data sending, and more specifically to a technique for registering a data send destination in an apparatus having a function of sending/receiving image data via a network.

2. Description of the Background Art

Conventionally, a variety of techniques of automatically registering a send destination in a destination list in a facsimile apparatus or the like having a function of selecting a send destination from a destination list that has been registered in advance. For example, Japanese Patent Application Laid-Open No. 11-122415(1999) discloses a technique of automatically registering a sender's address contained in a receive data on a destination list (address book) at the time of receiving an electronic mail in a facsimile apparatus for sending/receiving an image in electronic mail format. According to such an apparatus, it is possible to reduce the user's load concerning registration of a send destination on a destination list.

In such an apparatus as the facsimile apparatus disclosed in the above publication that can send/receive image data via a network, it is often the case that a display section for displaying the destination list is relatively small, so that there arises a situation that the display area of the display screen is limited. In the technique disclosed in the above publication, however, since a destination is automatically registered when data is received, even an unnecessary destination is registered, and the destination once registered is maintained unless the user deletes that destination. Therefore, the number of registered destinations becomes larger and larger in accordance with continuous use of the apparatus, which deteriorates the operability due to difficulty of selecting a send destination, as well as makes it impossible to take the most of the limited display area. Additionally, in the apparatus as described above, there has also been a request for effectively using a memory by decreasing the memory regions that are used for display and storage of the destination list.

Furthermore, even in appliances for which requirements of saving display area and memory region are not strict, a common problem arises that the operability in selecting a destination is deteriorated due to such automatic registration of a destination.

### SUMMARY OF THE INVENTION

The present invention is directed to a data sending apparatus.

According to the present invention, the present apparatus is a data sending apparatus capable of sending data to a terminal via a network, the apparatus comprising: (a) a receiver for receiving information representing whether or not the terminal is ready for receiving data from the terminal via the network; (b) a register for registering destinations of data sending via the network; (c) an interface for enabling a user to select a data send destination from the destinations registered in the register; (d) a sender for sending data to the data send destination selected by the user via the interface; and (e) a controller for controlling the interface so as to limit selection of the data send destination by the user on the basis of the information received from the receiver.

Therefore, it is possible to improve the operability regarding selection of data send destination by receiving from other terminal via a network information representing whether or not that other terminal is ready for receiving data, and limiting selection of data send destination to be made by the user on the basis of that information.

In a preferred embodiment of the present invention, the data sending apparatus is characterized in that the controller controls the interface so that only the terminal that is ready for receiving data is made to be selectable by the user as the data send destination.

Therefore, it is possible to prevent a send error from occurring in sending data by allowing the user to select only other terminal that is ready for receiving data as a data send destination.

Furthermore, the present invention is also directed to a data receiving apparatus, a data sending/receiving system, a data sending method, a data receiving method, a data sending/receiving method, a computer program and a recording medium.

Therefore, it is the first object of the present invention to provide a data sending apparatus which facilitates selection of send destination by giving a distinction between selecting conditions of destinations which are ready for receiving data and destinations which are not ready for receiving data.

Furthermore, it is the second object of the present invention to provide a data sending apparatus which can efficiently utilize the memory prepared for registering destinations by dynamically registering only send destinations that are ready for receiving data as destinations.

Furthermore, it is also an object of the present invention to provide a data sending apparatus which can efficiently utilize the memory prepared for registering destination by dynamically displaying only the send destinations that are ready for receiving data as destinations, in an apparatus equipped with means for displaying destinations.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 shows an appearance of a MFP (multi function peripheral) according to a first preferred embodiment;

FIG. 2 is a view showing a configuration of the MFP;

FIG. 3 is a block diagram showing a configuration provided for the MFP;

FIG. 4 is a front view showing a data receiving apparatus according to the first preferred embodiment;

FIG. 5 is a rear view showing a data receiving apparatus according to the first preferred embodiment;

FIG. 6 is a view showing a configuration of a data receiving apparatus;

FIG. 7 is a block diagram showing a configuration provided for the data receiving apparatus;

FIG. 8 is a view showing a connection state between the MFP and the data receiving apparatus according to the first preferred embodiment;

FIG. 9 is a flow chart showing an operation of the data receiving apparatus;

FIG. 10 is a flow chart showing an operation of the MFP at the time of activation;

FIG. 11 is a flow chart showing an operation of the MFP;

FIG. 12 is a flow chart showing an operation of a notice receiving process of the MFP;

FIG. 13 is a view showing an example of a display screen;

FIG. 14 is a view showing an example of a display screen;

FIGS. 15 are views showing an example of a display screen. (a) A view showing a state where the destination of the first row is deleted. (b) A View showing an example of shift-up relocation of the destination;

FIG. 16 is a flow chart showing an operation of a time-out process of the MFP;

FIG. 17 is a flow chart showing an operation of an image sending process of the MFP;

FIG. 18 is a view showing an operation of a notice receiving process of a MFP according to a second preferred embodiment;

FIG. 19 is a view showing an example of a display screen according to the second preferred embodiment;

FIG. 20 is a view showing an operation of a time-out process of the MFP according to the second preferred embodiment; and

FIG. 21 is a view showing an operation of an image sending process of the MFP according to the second preferred embodiment.

### DESCRIPTION OF THE PREFERRED EMBODIMENTS

In the following, preferred embodiments of the present invention will be described in detail while referring to the attached drawings.

### 1. First Preferred Embodiment

In a data sending/receiving system of a first preferred embodiment of the invention, a receiving end terminal (data receiving apparatus) regularly sends information representing whether or not the terminal is ready for receiving data to a sending end terminal (data sending apparatus), and the sending end terminal registers and displays only a receiving end terminal that is ready for receiving data as a send destination of data based on the above information. The information sent from the receiving end terminal includes information of requesting that it should be registered as a send destination (information representing that it has been activated), information representing that the terminal is being activated (regularly sent at a predetermined interval), and information representing that the terminal is to be shut down (sent directly before it is shut down).

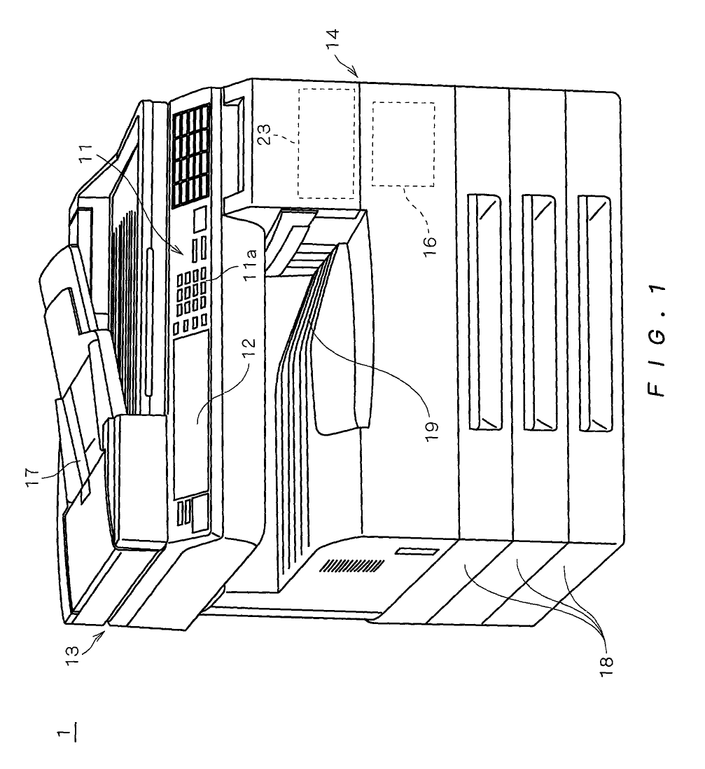

FIG. 1 shows an appearance of a multi function peripheral 1 (hereinafter, abbreviated as “MFP”) serving as a data sending apparatus in the present preferred embodiment. The MFP 1 is a combined machine having functions of a scanner, a copying machine, a printer, a facsimile and the like, and can send and receive data via a network.

As shown in FIG. 1, the MFP 1 has an operational section 11 equipped with a plurality of keys 11a for accepting a variety of operational instructions and inputs of data such as characters and numbers made on those keys by a user; a display section 12 for displaying information and the like concerning operational menus or acquired images; a scanner section 13 for photo-electrically reading a document to obtain image data; and a printer section 14 for printing an image on a recording sheet based on the image data.

Also, the MFP 1 has a feeder section 17 for feeding a document to the scanner section 13 on the top surface of the main body, a sheet supply section 18 for supplying the printer section 14 with a recording sheet in the lower part, a tray 19 to which a recording sheet on which an image has been printed by means of the printer section 14 is to be discharged in the center part, and a communication section 16 for sending/receiving image data and the like to/from external devices via a network and a storage section 23 for storing image data and the like in the interior. Though omitted in the drawing, the MFP 1 has a network interface, and the communication section 16 is connected to a network via the network interface so as to be able to send/receive various data to/from external devices.

While the display section 12 is used for displaying various displays including a list display of destinations of data sending, the operational section 11 is used for enabling a user to make various inputs including selection of send destination, and these sections function as an essential part of the user interface.

The scanner section 13 photo-electrically reads image information of photographs, characters, pictures and the like from a document to acquire image data. Acquired image data (density data) is converted into digital data in an image processing section (not shown), and after being subjected to a variety of well-known image processings, the resultant data is sent to the printer section 14 or the communication section 16 to be subjected to image printing or data sending, or alternatively stored in the storage section 23 for later use.

The printer section 14 prints an image on a recording sheet based on image data acquired by the scanner section 13, image data received from external devices by the communication section 16 or image data stored in the storage section 23.

In addition to sending/receiving facsimile data via public telephone lines, the communication section 16 sends/receives data using an electronic mail or the like to/from external devices connected to networks such as LAN and the INTERNET via the networks. Accordingly, the MFP 1 has not only a function of a facsimile apparatus performing usual facsimile communication but also a function of a sending/receiving terminal of electronic mail. Therefore, as an attached file of an electronic mail, various image data can be sent/received. The network communication conducted by the MFP 1 may be either wire communication or radio communication, and in the illustrated example, communication system according to wire communication is adopted.

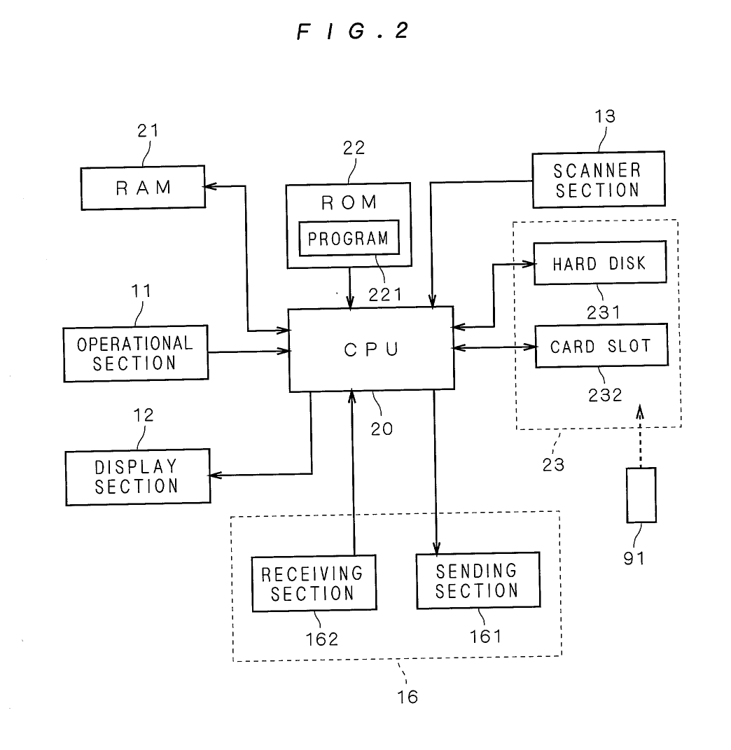

FIG. 2 is a block diagram showing a principal functional configuration of the MFP 1 according to the present preferred embodiment. The MFP 1 has a CPU 20 which performs a variety of operational processes and controls the general operation of the MFP 1, to which a RAM 21 for storing various data and a ROM 22 for storing a program 221 are connected. Furthermore, also the operational section 11, the display section 12, the scanner section 13 and the storage section 23 are connected to the CPU 20. The storage section 23 consists of a hard disk 231 for storing image data and the like and a card slot 232 for reading information from a memory card 91. The RAM 21 is a nonvolatile RAM.

This configuration enables delivery of various data between the RAM 21, the scanner section 13 the hard disk 231, and the memory card 91 mounted in the card slot 232 under the control of the CPU 20, and on the display section 12, information stored in the RAM 21, the hard disk 231 and the memory card 91 is displayed by the control of the CPU 20.

Furthermore, also the communication section 16 equipped with a sending section 161 and a receiving section 162 for sending/receiving data to/from external devices connected via networks is connected to the CPU 20.

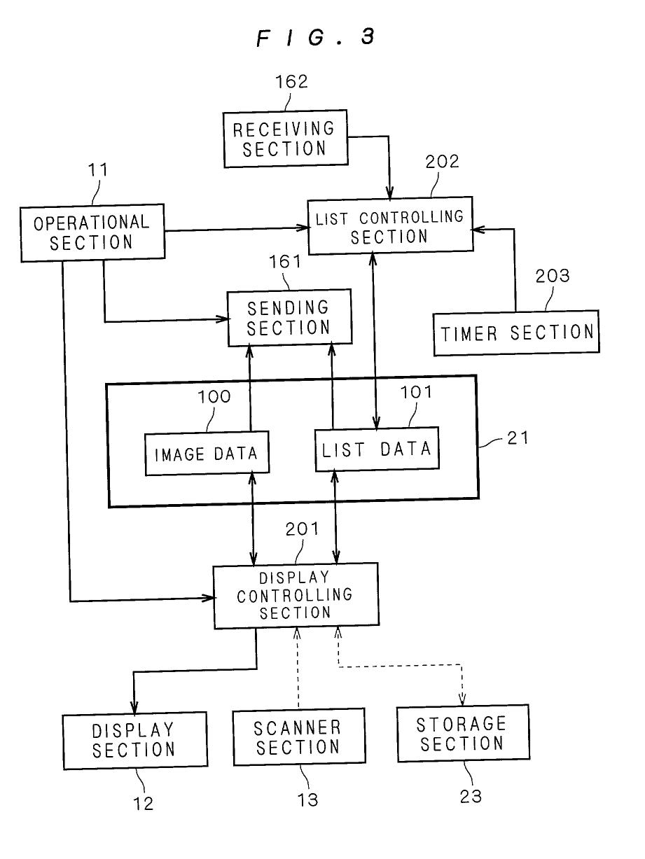

FIG. 3 is a view showing a functional configuration realized by the CPU 20 operating in accordance with a program 221 in the ROM 22, together with other configurations. Among the configurations shown in FIG. 3, a display controlling section 201, a list controlling section 202 and a timer section 203 are functions realized by the CPU 20 or the like.

The display controlling section 201 acquires image data 100 from the scanner section 13 and the storage section 23 to transfer it to the RAM 21 and stores the image data stored in the RAM 21 in the storage section 23, as well as displays a destination list or the like on the display section 12 by performing a necessary process on list data 101 or the like as will be described later.

The list controlling section 202 generates list data 101 by automatically registering destinations to which data is to be sent on the basis of information of a sender contained in a notice received by the receiving section 162. Furthermore, the list controlling section 202 has a function of discriminating whether or not a destination registered in the list data 101 is a destination which is currently ready for receiving data to correct the list data 101 on the basis of a notice received by the receiving section 162 and a signal from the timer section 203 which measures an elapsed time.

With regard to a send destination which was selected by a user by operating the keys 11a in the operational section 11 while viewing the list display of destination on the display section 12, the sending section 161 acquires the address of the send destination from the list data 101 and sends the image data to that address.

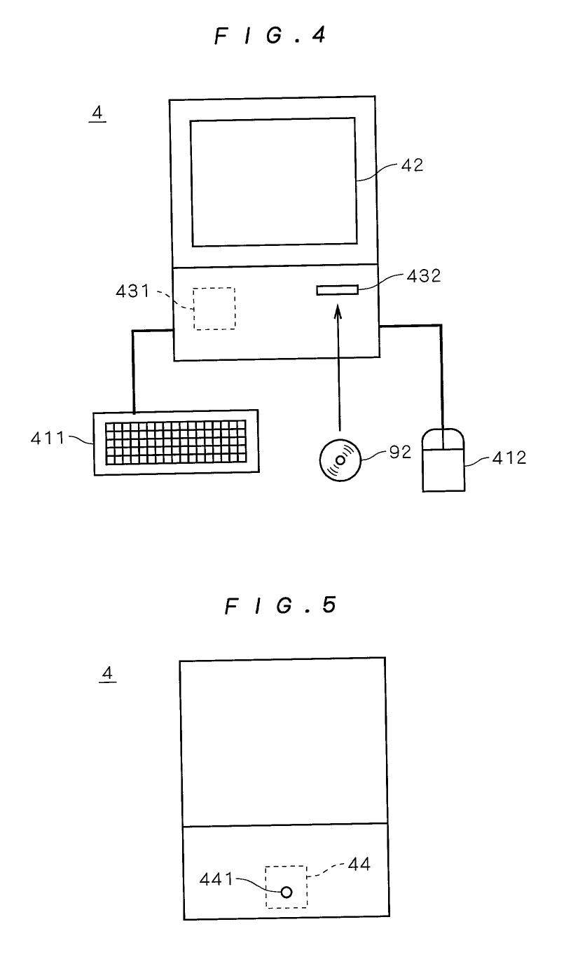

FIG. 4 shows an appearance of a data receiving apparatus 4 according to the present preferred embodiment. In this example, the hardware of the data receiving apparatus 4 is configured as a general personal computer, and as shown in FIG. 4, a keyboard 411 and a mouse 412 for accepting instructions from a user, and a display section 42 for displaying instruction menus to a user and obtained images are provided. Also, the data receiving apparatus 4 has a hard disk for storing data of image, programs, etc. therein, and a recording medium 92 recording variety of data can be mounted in a media reading device 432.

FIG. 5 is a rear view of the data receiving apparatus 4. The data receiving apparatus 4 has a communication section 44 incorporated therein for performing delivery of data via a network, and is connected to a network such as public telephone line, LAN, the INTERNET and the like by means of a network interface 441.

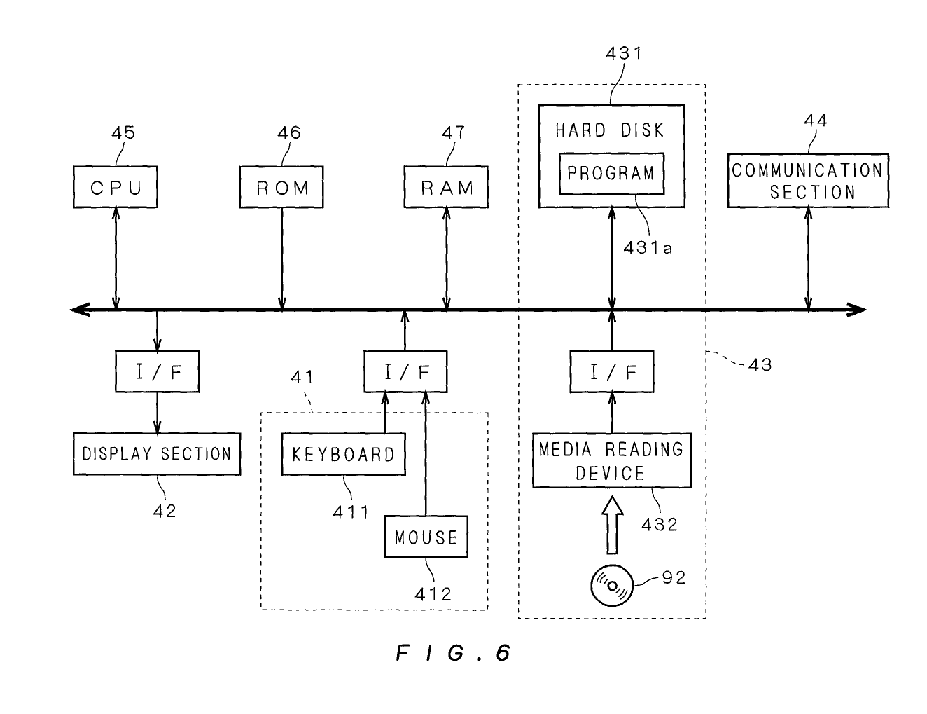

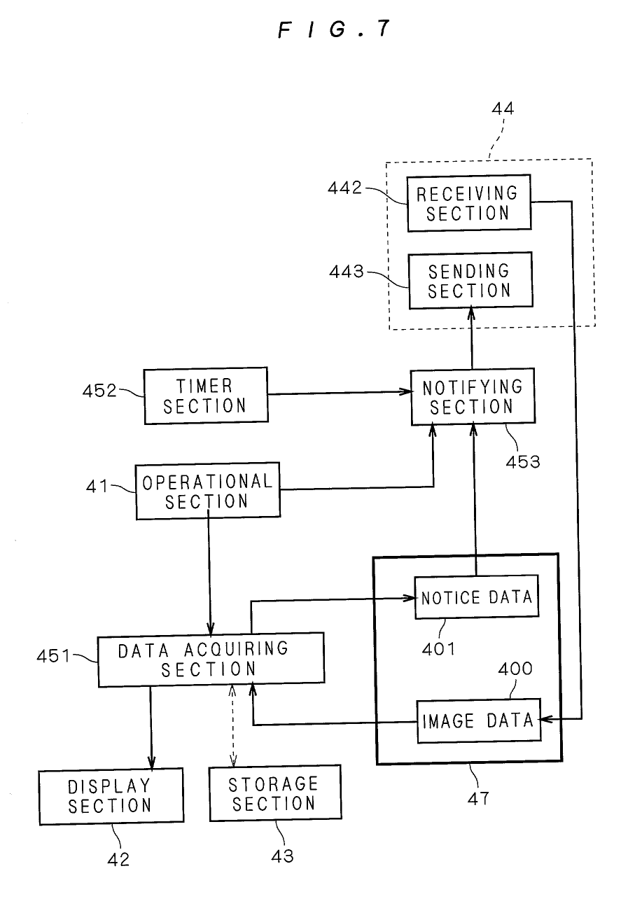

FIG. 6 is a block diagram showing a configuration of the data receiving apparatus 4. The hardware of the data receiving apparatus 4 is configured to be a general computer system in which a CPU 45, a RAM 47 and a ROM 46 are connected to a bas line. Additionally, as communication software, a program part of a novel notifying process (as will be described later) in accordance with the features of the present invention is installed. To the bas line, the display section 42, the keyboard 411 and the mouse 412 serving as an operational section 41 for accepting an input from a user, the hard disk 431 serving as a storage section 43 for storing data and a program 431a, the media reading device 432 for reading information from the recording medium 92 which is a recording medium such as optical disk, magnetic disk, magneto-optical disk and the like, and the communication section 44 for sending/receiving data to/from external devices such as MFP 1 are appropriately connected, for example, via a connection inter face (I/F).

Furthermore, delivery of various data is enabled under the control of CPU 45 between the RAM 47 and the hard disk 431 and the recording medium 92 mounted to the media reading device 432, and display of various information and display of images stored in the RAM 47, the hard disk 431, the recording medium 92 and the like are made on the display 42 under the control of the CPU 45.

FIG. 7 is a view showing a functional configuration realized by the CPU 45 by operating in accordance with the program 431 a in the hard disk 431, together with other configurations. The program 431 a is stored in the hard disk 431 from the recording medium 92 via the media reading device 432, and transferred to the RAM 47 from the hard disk 431, to be rendered executable at the CPU 45.

Among the configurations shown in FIG. 7, a data acquiring section 451, a timer section 452 and a notifying section 453 represent functions realized by the CPU 45 and the like.

The data acquiring section 451 performs delivery of various data between the storage section 43 and the RAM 47. In addition, it performs a necessary process on various data and image data 400 and the like received by a receiving section 442 to display it on the display section 42.

The timer section 452 has a timer function of measuring a time, and sends a designation signal to a notifying section 453 whenever a predetermined time has elapsed. The notifying section 453 generates a notice to be sent to the data sending apparatus such as MFP 1 on the basis of the instruction signal of the timer section 452 and notice data 401 and transfers it to a sending section 443.

Both the sending section 443 and the receiving section 442 are included in the communication section 44, and the sending section 443 receives a notice based on the notice data 401 from the notifying section 453 and sends the notice to the data sending apparatus such as MFP 1 via a network. Furthermore, the receiving section 442 receives the image data 400 sent from the data sending apparatus such as MFP 1 via a network and stores it in the RAM 47.

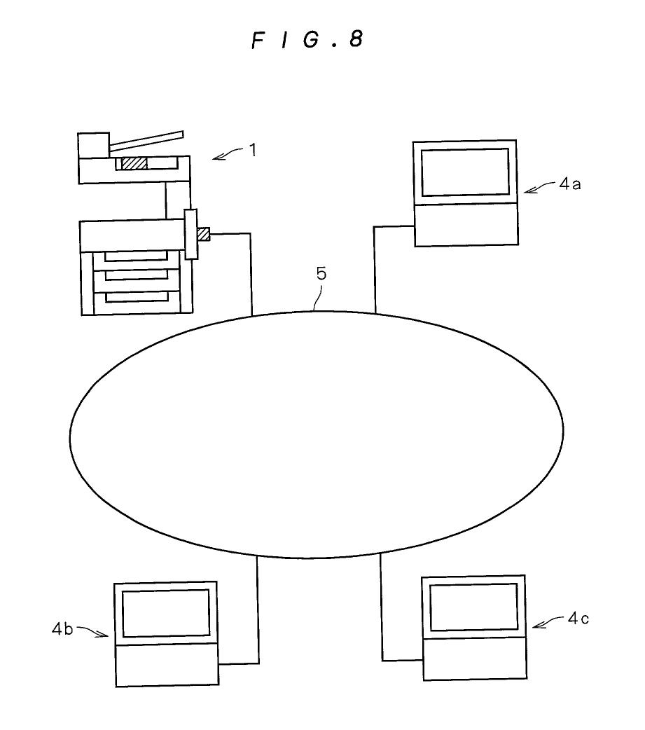

FIG. 8 is a view showing a data sending/receiving system which consists of the MFP 1 serving as a data sending apparatus and the data receiving apparatus 4 in accordance with the present preferred embodiment. Data receiving apparatuses 4a, 4b and 4c shown in FIG. 8 each has a configuration corresponding to the data receiving apparatus 4, and these data receiving apparatuses 4a, 4b and 4c are referred in general to as “data receiving apparatus 4”. Though an example in which only one MFP 1 is connected to a network 5 is shown in FIG. 8, a plurality of MFPs 1 may by connected. For each unit on the network 5, inherent identification information (ID information) which identifies each unit is assigned, to allow mutual identification on the network 5.

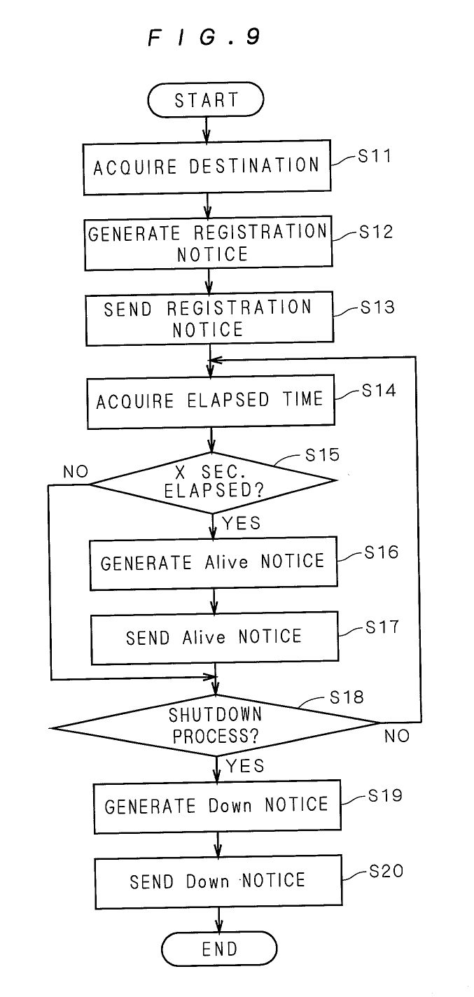

FIG. 9 is flow chart showing an operation when the data receiving apparatus 4 is connected to the network.

First, the data receiving apparatus 4 is activated to become ready for receiving data, and the data acquiring section 451 acquires destinations of all the data sending apparatus registered as a data sender including the MFP 1 and destinations of the data receiving apparatus 4 from the storage section 43 (step S11) and generates notice data 401 to store it in the RAM 47. Next, the notifying section 453 generates a notice by adding information representing registration request and information representing that it is ready for receiving data to the notice data 401 (hereinafter, the notice to which information representing registration request has been added will be referred to as “registration notice”) (step S12) and transfers it to the sending section 443. The sending section 443 sends the registration notice to all the data sending apparatus including the MFP 1 in accordance with the instruction by the notifying section 453 (step S13).

That is, the data receiving apparatus 4 can generate information representing whether or not the apparatus itself is ready for receiving data when the apparatus itself becomes ready for receiving data regardless of the presence or absence of a send request from the MFP 1, and send the information to the MFP 1 via the network. This includes various forms, however, the above-mentioned steps S12, S13 correspond to the form of generating information which represents that the apparatus itself has been activated to be ready for receiving data and sending the information to the MFP 1.

Next, the notifying section 453 acquires from the timer section 452 an elapsed time from the time when the last notice was sent (step S14), determines whether X seconds has elapsed (step S15), and if X seconds has elapsed, the notifying section 453 generates a notice to which information representing being ready for receiving data to the notice data (hereinafter, a notice to which only information representing being ready for receiving data will be referred to as “Alive notice”) (step S16) and sends the notice to the sending section 443. The sending section 443 sends the “Alive notice” to the MFP 1 in accordance with the instruction by the notifying section 453 (step S17). “X” is a predetermined value which is a criterion of every how many seconds the Alive notice is to be sent, and is set in advance at, for example, 200.

Accordingly, the data receiving apparatus 4 can regularly sends the information representing that it is ready for receiving data to the MFP 1 at a predetermined time interval.

Furthermore, the notifying section 453 determines whether or not a shutdown process of the user receiving apparatus 4 has been made by a user (step S18), and if a shutdown process has been made, the notifying section 453 generates a notice in which information representing that it is no longer ready for receiving data is added to the notice data 401 (hereinafter, a notice to which information representing that it becomes no longer ready for receiving data will be referred to as “Down notice”) (step S19), and transfers the Down notice to the sending section 443. The sending section 443 sends the Down notice to the MFP 1 in accordance with the instruction of the notifying section 453 (step S20). The operations of steps S14 to S18 are repeated until a shutdown process is made.

As a result of this, the data receiving apparatus 4 can send the information that represents that it is no longer ready for receiving data from that time to the MFP 1 via the network when a shutdown process is made so that it is no longer ready for receiving data regardless of the presence or absence of a send request from the MFP 1.

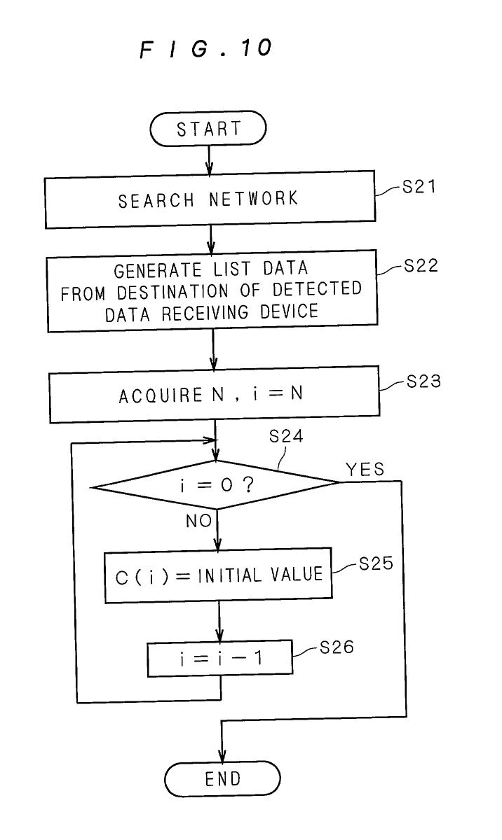

FIG. 10 is a flow chart showing an operation at the time of activating the MFP 1. Upon being activated, the MFP 1 first performs the operation shown in FIG. 10 and generates the list data 101 in which destinations of data sending via the network are registered.

First, the sending section 161 sends data of requesting a response to all the data receiving apparatus that can be recognized as a network terminal by the MFP 1 at that point of time, so as to detect the respective addresses of such data receiving apparatuses being connected on the network 5. Then, the receiving section 162 receives a response from each data receiving apparatus being connected to the network 5, and searches and confirms the data receiving apparatus connected to the network 5 by confirming the response by the list controlling section 202 (step S21). The list controlling section 202 generates the list data 101 while designating the respective addresses of the data receiving apparatuses that have been detected on the network 5 as destinations of data sending (step S22).

Next, a number N of registered destinations of the list data 101 is acquired and set for i (step S23). It is determined whether or not i is 0 (step S24), and if i is not 0, an initial vale is set for the counter C(i) of the destination registered in ith order of the list data 101 (step S25), and i is decremented (step S26). Steps S24 to S26 are repeated until i becomes 0, and the counter C(i) is initialized for all the destinations registered in the list 101. In this connection, the counter C(i) is a value which is a reference for the time when the ith destination in the list data 101 is subsequently recognized as being ready for receiving data, and set in advance at for example, 60, as an initial value. These are operations at the time of activating the MFP 1.

It is also possible that when the MFP 1 is shut down, the MFP 1 stores the list data 101 at that point of time in the storage section 23 and acquires the list data 101 by reading the list data again at the time of activation, rather than that the MFP 1 newly generates the list data 101 every time the MFP 1 is activated. Furthermore, it is also possible that the list data 101 is generated when a regular connection confirmation as will be described later is made from the data receiving apparatus, rather than that the list data 101 is generated at the time of activation.

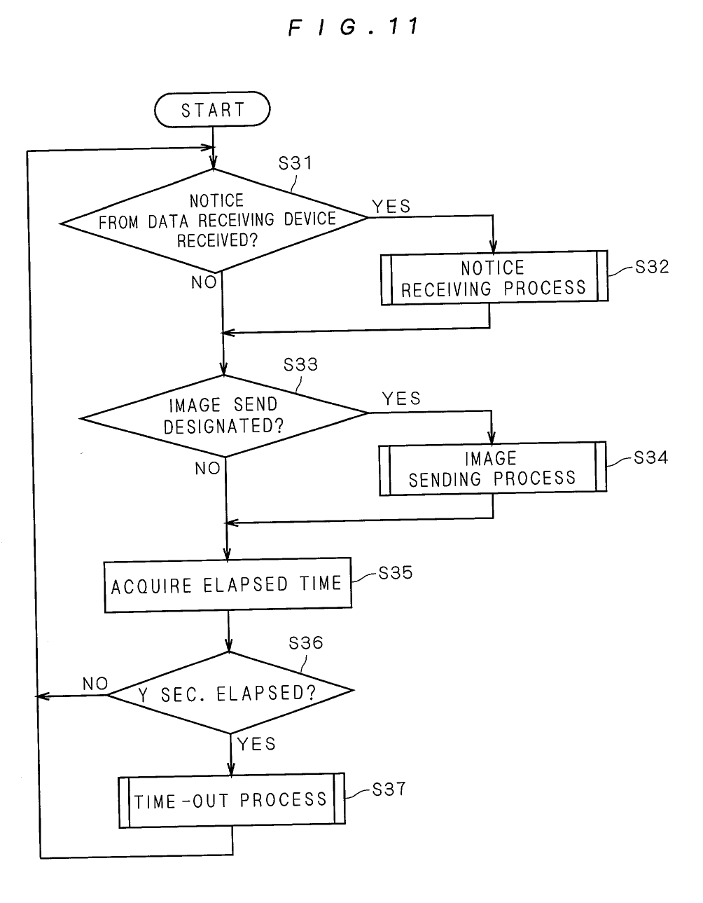

FIG. 11 is a flow chart showing an operation after activation of the MFP 1. A normal operation after activation of the MFP 1 will be explained with reference to FIG. 11.

First, the list controlling section 202 determines whether or not a notice to which information representing whether or not being ready for receiving data from any of the data receiving apparatuses connected to the network such as data receiving apparatus 4 connected to the receiving section 162 via the network 5 (step S31), and performs a notice receiving process if a notice is received (step S32). If a notice is not received, it determines whether or not a designation for sending an image is made by the user (step S33). In the case where a designation for sending an image is made, an image sending process is performed (step S34).

In the case where neither a designation for image sending is made, the list controlling section 202 acquires the elapsed time from the time when it executed the step S37 the last time from the timer section 203 (elapsed time of executing step S35 at the first time is 0) (step S35), and determines whether or not Y seconds has elapsed (step S36). If Y seconds has not elapsed, steps S31 to S36 are repeated, and if Y seconds has elapsed, a time-out process is performed (step S37). “Y” is a predetermined value which is a criterion for judging every how may seconds a time-out process is to be executed (step S37), and set at, for example, 5.

That is, the MFP 1 regularly performs a time-out process while receiving a notice from the data receiving apparatus 4 via the network or supervising an occurrence of interruption of image sending by the user.

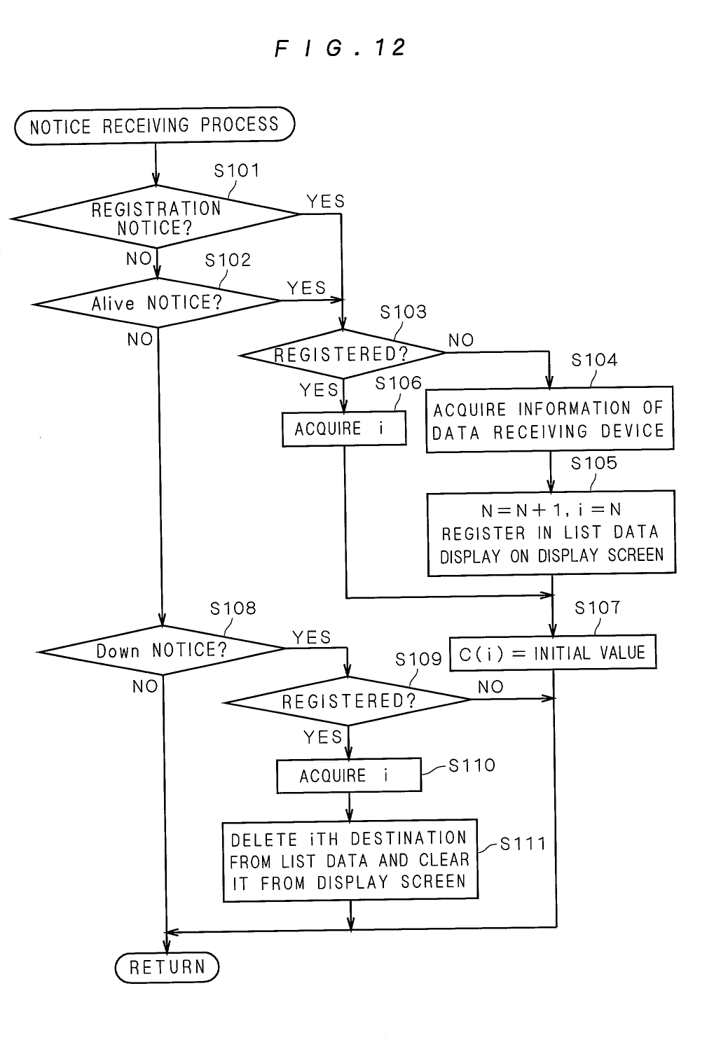

FIG. 12 is a flow chart showing the notice receiving process shown in FIG. 11 (step S32) in detail. FIGS. 13 to 15 are views showing examples of a display screen 200 when the display controlling section 201 displays the list data 101 which is the destinations of data sending on the display section 12. For example, in the case where the display screen 200 shown in FIG. 13 is displayed, it means that only the address “aaa.cojp” of the data receiving apparatus 4a shown in FIG. 8 is registered as a destination in the list data 101. Using these drawings, an operation in the notice receiving process of the MFP 1 at the time of receiving a notice from the data receiving apparatus 4 will be explained.

First, the list controlling section 202 determines whether the received notice is a registration notice, an Alive notice or a Down notice on the basis of the information contained in the received notice (steps S101, S102, S108).

In the case where it is determined to be a registration notice, whether or not the data receiving apparatus 4 from which the registration notice was received is registered in the list data 101 by comparing a destination of the data receiving apparatus contained in the registration notice with destinations registered in the list data 101 (step S103). If the destination has not been registered yet, the data receiving apparatus 4 that sent the registration notice is a new destination, so that information representing destination contained in the registration destination is acquired (step S104). Furthermore, the number of destinations N is incremented to be set for i, the acquired destination is registered in the ith position of the list data 101 and the address of that data receiving apparatus is additionally displayed on the display screen 200 (step S105), and an initial value is set for the counter C(i) (step S107). If the destination has been already registered, “i” which represents the order in the list data 101 where the destination is registered is acquired (step S106), and an initial value is set for the counter C(i) (step S107).

Also in the case where it is determined to be an Alive notice, steps S103 to 107 are executed in the same manner as the case of the registration notice. That is, in the case where a registration notice and an Alive notice are received from the data receiving apparatus 4b and the data receiving apparatus 4c, respectively, in the condition shown in FIG. 13, the MFP 1 determines that both of them are new destinations (step S103), registers the address “bbb.cojp” of the data receiving apparatus 4b and the address “ccc.cojp” of the data receiving apparatus 4c in the list data 101 as shown in FIG. 14, additionally displays the addresses of these data receiving apparatuses on the display screen 200 (step S105), and sets an initial value for the counter C(i) (step S107). In the case where a registration notice is received from the data receiving apparatus 4a, a registration will not be made again because step S103 is executed, and the counter C(i) is initiated as is the case when an Alive notice is received.

Accordingly, it is possible to receive information which represents that a data receiving apparatus is ready for receiving data from the data receiving apparatus via a network and register a destination of the data receiving apparatus being ready for receiving data as a destination of data sending via the network on the basis of the information. Furthermore, the destination is additionally displayed in connection with the registration, and a selective control with a user interface related to selection of send destination is achieved.

In the case where the received notice is a Down notice, it is determined whether the data receiving apparatus from which the Down notice was sent has been registered in the list data 101 (step S109), and if it has been already registered, “i” which represents which order the destination is registered in the list data 101 is acquired (step S 010), the ith destination is deleted from the list data 101 and the destination is cleared from the display screen 200 (step S111).

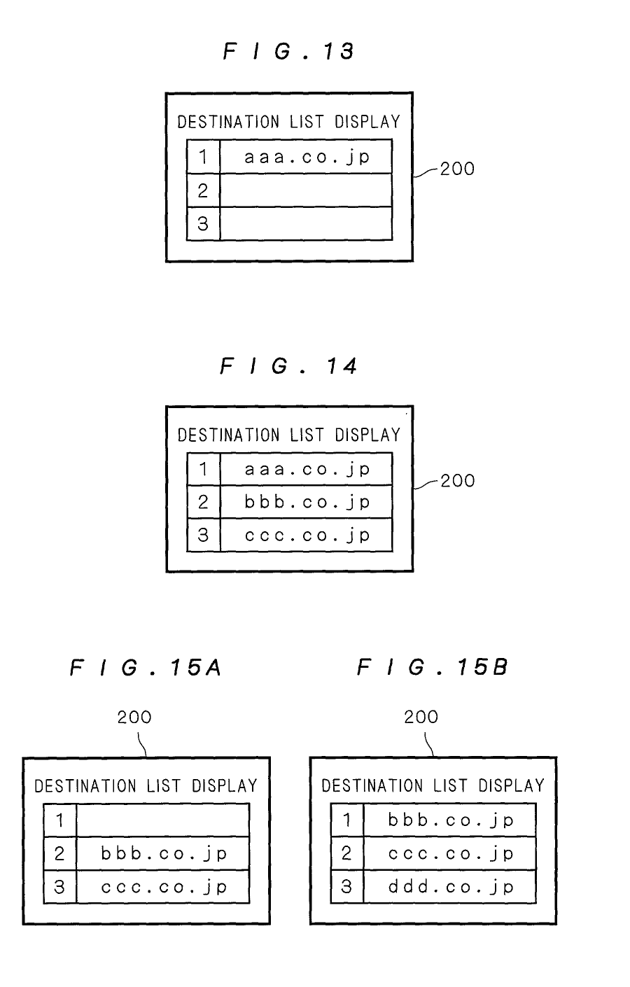

That is, for example, in the condition shown in FIG. 14, when a Down notice is received from the data receiving apparatus 4a, the MFP 1 deletes the address “aaa.cojp” of the data receiving apparatus 4a from the list data 101 as shown in FIG. 15(a) and clears it from the display screen 200.

Accordingly, it is possible to receive information representing that a data receiving apparatus is not ready for receiving data from that data receiving apparatus via a network and cancel registration of a destination of the data receiving apparatus being no longer ready for receiving data on the basis of the information, so that when the data receiving apparatus is not ready for receiving data, it can be automatically deleted from destinations. Furthermore, in connection with the cancel of registration, the destination is cleared from the display, whereby a selective control with a user interface related to selection of send destination is achieved.

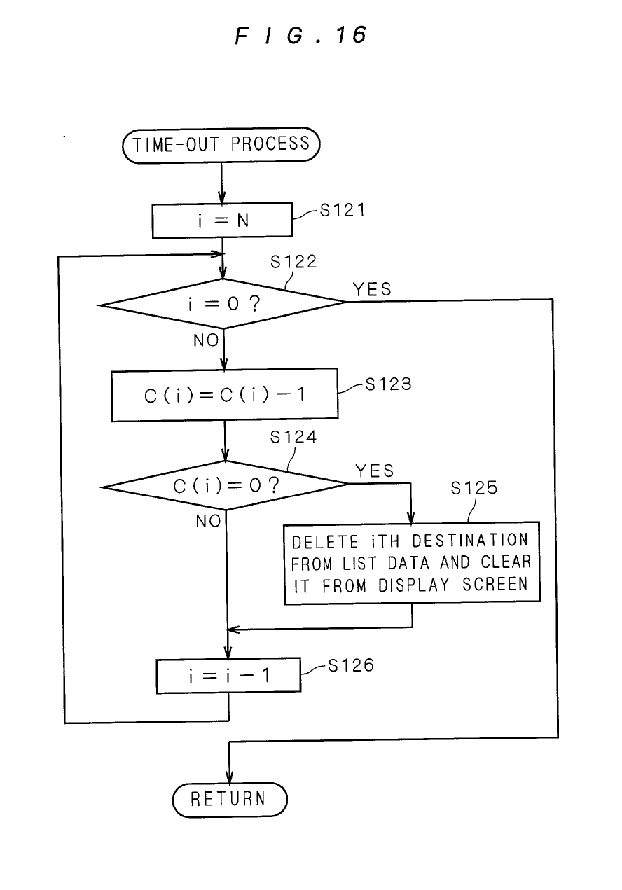

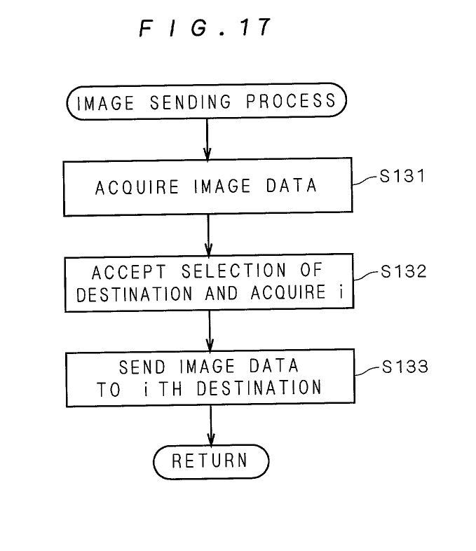

FIG. 16 is a flow chart showing details of the time-out processing shown in FIG. 11 (step S37). Using FIG. 16, an operation of the MFP 1 for deleting the data receiving apparatus from which a notice has not been received for not less than a predetermined time from the list data 101 will be explained.

First, the list controlling section 202 sets the number of destinations N to i (step S121), and determines whether or not i is 0 (step S122). If i is 0, there is no destination registered in the list data, the flow returns to the normal process, and if i is not 0, the ith counter C(i) is decremented (step S123).

Next, whether or not the counter C(i) is 0 is determined (step S 124), and if the counter C(i) is 0, which means that a notice has not been received for a predetermined time from the data receiving apparatus of the ith destination (time-out), the data receiving apparatus of the ith destination is regarded as not normally operating, and it is deleted from the list data 101 and cleared from the display screen 200 (step S125). If the counter C(i) is not 0, it is kept registered in the list data 101, and kept displayed on the display screen 200. Since the counter C(i) is necessarily initiated when a notice other than a Down notice is received (FIG. 12: step S107), in the case where the counter C(i) is not 0, it can be determined that a predetermined time has not elapsed from when the last alarm was received (not timed-out).

Furthermore, since the time-out determination is made for all the destinations registered in the list data 101 (step S124), steps S122 to S126 are repeated until the i is 0 by decrementing the i (step S126).

That is, with respect to the data receiving apparatus 4a that has been registered in the condition shown in FIG. 14, for example, the MFP 1 deletes the address thereof from the list data as shown in FIG. 15(a) and clears from the display screen 200 when the counter C(i) becomes 0 if no notice is received after that from the data receiving apparatus 4a.

Consequently, even when the data receiving apparatus 4 cannot send a notice due to a failure or the like (that is, it can be regarded that the data receiving apparatus 4 is not able to receive data), it is possible to delete the data receiving apparatus 4 from the list data 101 and clear from the display screen 200, whereby a selective control with a user interface related to selection of send destination is achieved.

In this connection, the destination raw deleted in response to the Down notice may be kept blank (the row “1” in the example of FIG. 15(a)), it is preferred that the display on the display screen 200 is relocated so that such a blank row is embedded. In the latter case, after the display is changed to the condition shown in FIG. 15(a), the row “I” is relocated to “bbb.cojp” and the row “2” is relocated to “ccc.co.jp”, and as shown in FIG. 15(b), an address of other registered data receiving apparatus 4 (not shown) is displayed in the row “3” by being shifted up. In this way, it becomes possible to display a number of send possible addresses even in a small display screen. Furthermore, such a shift-up relocation of the list may be effected when the user presses down a predetermined key in the operational section 11.

FIG. 17 is a flow chart showing details of the image sending process shown in FIG. 11 (step S34). Using FIG. 17, an operation of the MFP 1 when a user sends the image data 100 will be explained.

First, a designation to send an image is made by the user by operating the operational section 11, and the scanner section 13 acquires the image data 100 by reading the image of a document (step S131).

On the other hand, a list of destinations to which sending is enabled at this point of time is usually displayed on the display screen 200 as shown in FIG. 14. For convenience of illustration, only three addresses are shown in FIG. 14, however, it is also possible to select an address group of the number' corresponding to the available display size of the display screen 200 from a larger number of destinations, and call the address group on the display screen 200. Then, the user selects a desired destination by means of the operational key 11 a while viewing the destination list display on the display screen 200. That is, in this example, the row number of displayed address and the number of key 11a is mutually corresponded, and in the example of FIG. 14, by pressing down the key corresponding to “2”, an operation of selecting “bbb.cojp” is achieved.

The sending section 161 accepts such a selecting input from the operational section 11 made by the user, acquires i representing the send destination (step S1 32), and sends the image data 100 to the ith destination in the list data 101 (step S133).

Accordingly, it is possible to make a control of limiting selection of a data send destination by the user on the basis of the received notice, and to make only a data receiving apparatus that is ready for receiving data selectable by the user as a data send destination, and to send data to the send destination selected by the user.

Also, a registration function which allows direct input of an address by using the operational key 10a as a character key, a numerical key or a symbol key may be provided in addition to allowing the user to select a destination of the image data 100 by operating the operational key 11a while viewing the display screen 200. Furthermore, the data to be sent is not necessarily be image data that has been read from the scanner section 13, and for example, image data which is preliminarily stored in the hard disk 231 may be read out for use. Furthermore, the data to be sent may not be image data.

As described above, according to the data sending/receiving system of the first preferred embodiment of the present invention, each data receiving apparatus 4 is registered and displayed as a destination in the MFP 1 serving as a data sending apparatus only when the data receiving apparatus 4 is ready for receiving data, and when the data receiving apparatus 4 becomes no longer ready for receiving data, registration as a destination is canceled and display thereof is cleared. Therefore, in the MFP 1 serving as a data sending apparatus, only the data receiving apparatuses that are ready for receiving data are displayed to be selectable by the user, which improves operability, and makes it possible to efficiently use the display area on the display screen and the use area of the memory to be used for display and registration of destination.

### 2. Second Preferred Embodiment

In the data sending/receiving system of the first preferred embodiment, when a data receiving apparatus (for example, data receiving apparatus 4) becomes no longer ready for receiving data, the destination of that data receiving apparatus is deleted from the list data 101 and cleared from the display screen 200 in the MFP 1, thereby providing a limitation for selection of data send destination by the user. To the contrary, in a data sending/receiving system of a second preferred embodiment, even when the data receiving apparatus 4 becomes no longer ready for receiving data, the MFP 1 keeps that data receiving apparatus 4 without deleting it from the list data 101, but changes the form of display on the display screen 200, thereby providing a limitation for selection of data send destination by the user. To be more specific, the MFP 1 of the second preferred embodiment changes the form of the destination display on the display screen 200 in the case where it receives from the data receiving apparatus 4 information representing that the data receiving apparatus 4 becomes no longer ready for receiving data or in the case where it has not received from the data receiving apparatus 4 information representing that the data receiving apparatus 4 is ready for receiving data. Also, when the data receiving apparatus 4 is selected by the user as a data send destination, the MFP 1 suspends sending of that data and sends the data after the data receiving apparatus 4 becomes ready for receiving data.

Since the basic configuration and operation of the data sending/receiving system according to the second preferred embodiment are as same as those of the data sending/receiving system according to the first preferred embodiment, explanations for the overlapping parts will be omitted.

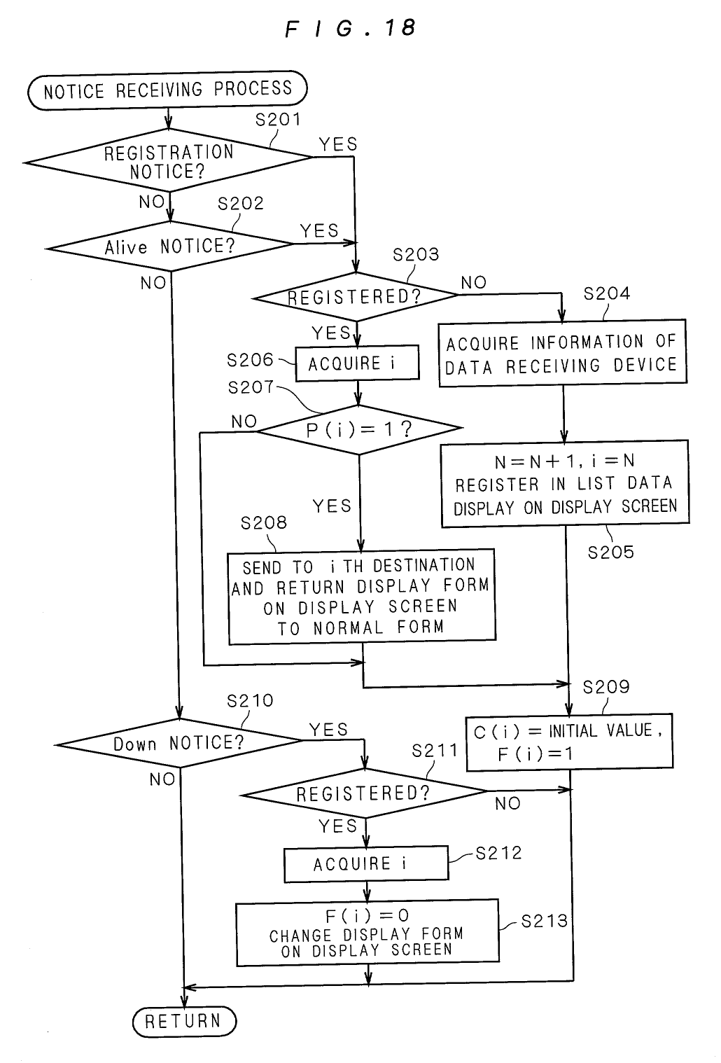

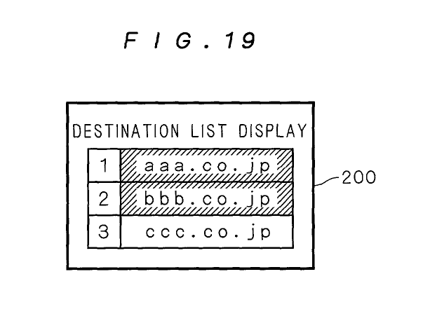

FIG. 18 is a flow chart showing details of a notice receiving process (FIG. 11: step S32) of the MFP 1 according to the second preferred embodiment. The process from steps S201 to S205 is the same as that of steps S101 to S105 of FIG. 12. That is, also in the second preferred embodiment, as is the case of the first preferred embodiment, in the case where a registration notice or an Alive notice is received, it is determined whether or not the destination of the data receiving apparatus 4 from which the notice was received is registered in the list data 101, and if the destination has not been registered yet, a process of registering the destination in the list data 101 is executed.

If it has been already registered, i is acquired (step S206), whether or not the flag P(i) is 1 (step S207), and if the flag P(i) is 1, standby image data is sent to the ith destination, and the display form on the display screen 200 of the destination of the data receiving apparatus 4 from which the notice was sent is returned to the normal form (step S208). The flag P(i) is such that when sending of image data is designated in the condition that the data receiving apparatus 4 registered in the ith position is not ready for receiving data, the MFP 1 represents that it stands for the data receivable condition of the data receiving apparatus 4.

Next, the flag F(i) is set at 1 when initiating the counter C(i) (step S209). The flag F(i) is a flag that shows whether or not the ith data receiving apparatus 4 from which the notice was sent is ready for receiving data, and if it is ready for receiving data it is set at 1, and if it is not ready for receiving data, it is set at 0.

In the case where it is determined that the received notice is a Down notice (step S210), whether or not the destination of the data receiving apparatus 4 from which the notice was sent has been registered in the list data 101 yet (step S211), and if it has been already registered, i is acquired (step S212), the flag F(i) is set at 0, and the display form on the display screen 200 is changed (step S213). As for a concrete example of changing of the display form, it is possible to change the display density so that the address “ccc.cojp” of the data receiving apparatus being ready for receiving data is displayed in black on the white background, and the addresses “aaa.cojp” and “bbb.cojp” of the data receiving apparatuses not being ready for receiving data are displayed in black on the gray background, as shown in FIG. 19, for example. Furthermore, as for these, different display sizes may be applicable, and when a color display is used, the display colors may be differ from each other. Also distinguished display of constant display and blink display can be used.

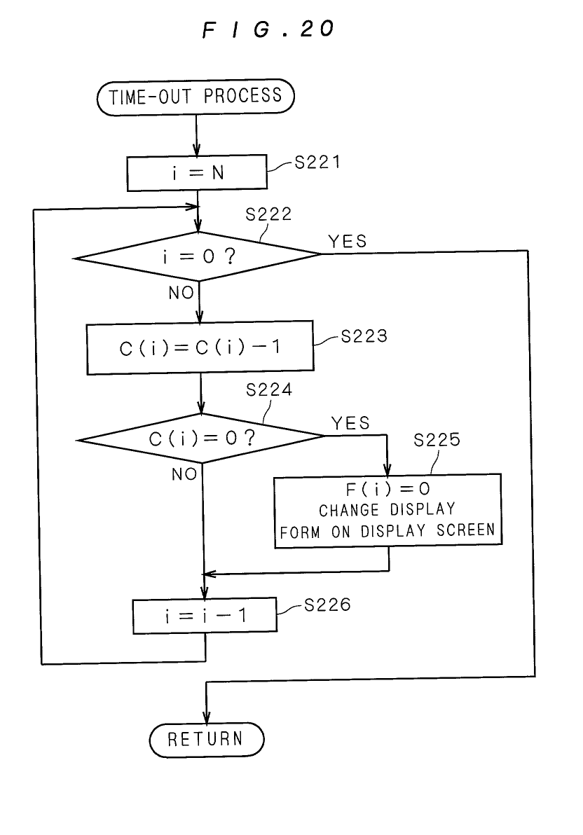

FIG. 20 is a flow chart showing details of the time-out process (FIG. 11: step S37) of the MFP 1 according to the second preferred embodiment. Steps S221 to S226 are the process corresponding to steps S121 to S126 of the time-out process (FIG. 16) in the first preferred embodiment. In the first preferred embodiment, a process for deleting the timed-out destination from the list data 101 and clearing from the display screen 200 was executed in step S125, however, the present preferred embodiment differs from the first preferred embodiment in that a process of setting the flag F(i) of the timed-out destination at 0 and changing the display form on the display screen 200 (step S225) is executed.

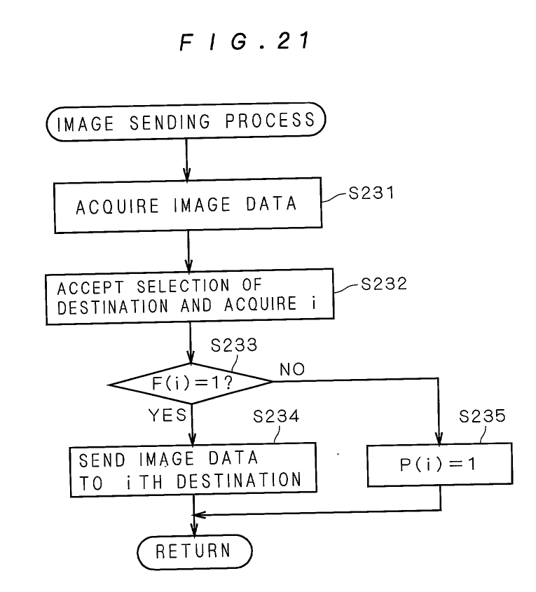

FIG. 21 is a flow chart showing details of the image sending process (FIG. 11: step S34) of the MFP 1 according to the second preferred embodiment.

First, in accordance with the destination of the user, image data 100 to be sent is acquired (step S231).

Next, the sending section 161 accepts a selection input made by a user from the operational section 11 and acquires i (step S232), and whether or not the flag F(i) is 1 is determined (S233). If the flag F(i) is 1, the image data 100 is sent (step S234) because it is confirmed that the destination is ready for receiving data. If the flag F(i) is not 1, 1 is set for the flag P(i) (step S235) because the destination that is not ready for receiving data is selected.

In the manner as described above, by displaying the data receiving apparatus 4 that is ready for receiving data and the data receiving apparatus 4 that is not ready for receiving data in different forms on the display screen 200 on the basis of the received notice, it is possible to confirm the conditions of the destinations on the user interface. Furthermore, when a data receiving apparatus that is not ready for receiving data is selected by the user, it is possible to control so that data is sent after that data receiving apparatus becomes ready for receiving data (FIG. 18: step S208).

### 3. Modification

In the above, preferred embodiments of the present invention have been explained, the present invention can be modified in various manners without limited to the above preferred embodiments.

For example, the operational section 11 is not limited to the key input type as is the above preferred embodiments, but any types are applicable insofar as designation or data such as character and number can be inputted by a user's operation. For example, those incorporated to the display such as touch-panel display or tablet may be used.

Furthermore, the program for making the CPU 20 execute the process according to the above preferred embodiment may not necessarily be written to the ROM 22 in advance. For example, it is also possible that the program is read out from the memory card 91 via the card slot 232 in advance, and the program is executed after being stored in the stationary disk 231. Likewise, also the program to be executed by the CPU 45 of the data receiving apparatus 4 may not necessarily be stored in the hard disk 431. For example, it may be written to the ROM 46 in advance.

In addition, in the MFP 1 and the data receiving apparatus 4, all of the series of the processes are executed in software processing, however, a part or all of these processes may be implemented by special circuitry.

Furthermore, the information representing whether or not the data receiving apparatus 4 is ready for receiving data that is sent by the data receiving apparatus 4 may be included in other data. For example, when the MFP 1 receives facsimile data and mail data from the data receiving apparatus 4, registration of a destination may be performed on the basis of the above information contained in these data.

Furthermore, in the above preferred embodiments, the MFP 1 does not send any replay for the notice of the data receiving apparatus 4, the MFP 1 may send data which represents that it has received the notice and registered as a destination to the data receiving apparatus 4. In such a case, the data receiving apparatus 4 becomes possible to determine whether or not the apparatus itself has been registered, and to determine the necessity of an Alive notice or a Down notice on the basis of that data.

Furthermore, the notice of the data receiving apparatus 4 may be sent in response to a designating operation by the user.

Furthermore, information for changing the value of the counter C(i) of the MFP 1 may be added to the notice of the data receiving apparatus 4. In this case, the data receiving apparatus 4 can register a time zone during which the apparatus itself can receive data in the MFP 1 in advance.

Furthermore, in the second preferred embodiment as described above, the destination of the data receiving apparatus 4 from which the Down notice was received or which has been timed-out is displayed in gray, however, it may be deleted from the list data 101 after a predetermined time has elapsed from it is displayed in gray, or it may be displayed in gray at the time of time-out and deleted when the Down notice is received.

In the above preferred embodiments, destinations registered in the list data 101 are usually displayed on the basic screen (display screen 200) of the display section 12, and the display of destination on the display section 12 was corrected (display, delete, or change of display form) in association with a correction (registration or deletion of destination) of the list data 101 on the basis of the notice from the data receiving apparatus 4. However, it is also possible that when a screen for selecting a destination is called by a designation of the user, or when the apparatus enters a data sending mode, the destinations registered in the list data 101 (which are ready for receiving data) are displayed with reference to the registration situation of the list data 101, without displaying destinations on the basis screen of the display section 12.

While the invention has been described in detail, the foregoing description is in all aspects illustrative and not restrictive. It is understood that numerous other modifications and variations can be devised without departing from the scope of the invention.

What is claimed is:

1. A data sending apparatus capable of sending data to a terminal via a network, the apparatus comprising:
(a) a receiver for receiving information from said terminal via said network representing whether or not said terminal is ready for receiving data;
(b) a register for registering destinations of data sending via said network;
(c) an interface for enabling a user to select a data send destination from said destinations registered in said register;
(d) a sender for sending data to said data send destination selected by said user via said interface; and
(e) a controller for controlling said interface so as to limit selection of said data send destination by said user on the basis of said information received from said receiver.

2. The data sending apparatus according to claim 1, wherein
said controller controls said interface so that only said terminal that is ready for receiving data is made to be selectable by said user as said data send destination.

3. The data sending apparatus according to claim 1, wherein
said controller registers said terminal that becomes ready for receiving data in said register as a destination of data sending and cancels registration of said terminal that becomes no longer ready for receiving data, on the basis of said information received by said receiver.

4. The data sending apparatus according to claim 1, wherein
said interface includes a display for displaying said destinations.

5. The data sending apparatus according to claim 4, wherein
said controller controls said interface, on the basis of said information received by said receiver, so that said terminal that is ready for receiving data is displayed on said display as a destination, and said terminal which is not ready for receiving data is not displayed.

6. The data sending apparatus according to claim 5, wherein
said controller controls said interface, on the basis of said information received by said receiver, so that said terminal that becomes ready for receiving data is registered in said register as said destination, and registration of said terminal that becomes no longer ready for receiving data is canceled, and only said destinations that are registered in said register are displayed on said display.

7. The data sending apparatus according to claim 4, wherein
said controller controls said interface, on the basis of said information received by said receiver, so that said terminal that is ready for receiving data and said terminal that is not ready for receiving data are displayed on said display in different forms.

8. The data sending apparatus according to claim 7, wherein
said controller controls said sender so that when said terminal that is not ready for receiving data is selected by said user as said data send destination via said interface, data is sent after said terminal becomes ready for receiving data.

9. The data sending apparatus according to claim 1, further comprising:
(f) a reader for reading an image of a document to acquire image data,
wherein said sender can send said image data that has been read by said reader.

10. A data receiving apparatus capable of receiving data from a terminal via a network, the apparatus comprising:
(a) a generator for generating information representing whether or not said data receiving apparatus itself is ready for receiving data; and
(b) a sender for sending said information generated by said generator to said terminal via said network at least when said data receiving apparatus itself becomes ready for receiving data or becomes no longer ready for receiving data independently of receiving a send request from said terminal.

11. The data receiving apparatus according to claim 10, wherein
said sender further sends said information generated by said generator regularly at a predetermined time interval.

12. A system capable of transmitting data via a network, the system comprising:
(a) a data receiving apparatus including:
a generator for generating information representing whether or not said data receiving apparatus itself is ready for receiving data; and
a sender for sending said information generated by said generator to said network at least when said data receiving apparatus itself becomes ready for receiving data or becomes no longer ready for receiving data independently of receiving a send request via said network; and
(b) a data sending apparatus including:
a receiver for receiving from said data receiving apparatus said information representing whether or not said data receiving apparatus is ready for receiving data via said network;
a register for registering destinations of data sending via said network;
an interface for enabling a user to select a data send destination from said destinations registered in said register;
a sender for sending data to said data send destination selected by said user via said interface; and
a controller for controlling said interface so as to limit selection of said data send destination by said user on the basis of said information received from said receiver.

13. The system according to claim 12, wherein
said controller controls said interface so that only said data receiving apparatus that is ready for receiving data is made to be selectable by said user as said data send destination.

14. A data sending method via a network, the method comprising the steps of:
(a) receiving information representing whether a data receiving end terminal is ready for receiving data via said network; and
(b) limiting selection of a data send destination by a user in a data sending end terminal on the basis of said information received.

15. The data sending method according to claim 14, wherein
in said step (b), only said data receiving end terminal that is ready for receiving data is selectable as said data send destination by said user.

16. A data receiving method via a network, comprising the steps of:
(a) generating information representing whether a data receiving end terminal is ready for receiving data in said data receiving end terminal; and
(b) sending said information from said data receiving end terminal to a data sending end terminal at least when said data receiving end terminal becomes ready for receiving data and becomes no longer ready for receiving data independently of receiving a send request from said data sending end terminal.

17. A data sending/receiving method via a network, comprising the steps of:
(a) sending information representing whether or not a data receiving end terminal is ready for receiving data from said data receiving end terminal to a data sending end terminal via said network; and
(b) limiting selection of a data send destination by a user in said data sending end terminal on the basis of said information received.

18. The data sending/receiving method via a network according to claim 17, wherein
in said step (b), only said data receiving end terminal that is ready for receiving data is selectable as said data send destination by said user.

19. A computer program for controlling a computer to operate as an apparatus which comprises:
(a) a receiver for receiving from a terminal via a network information representing whether or not said terminal is ready for receiving data; and
(b) a controller for limiting selection of data send destination by a user on the basis of said information received by said receiver.

20. The computer program according to claim 19, wherein
said controller makes only said terminal that is ready for receiving data selectable by said user as said data send destination.

21. The computer program according to claim 20, wherein
said controller displays said terminal that is ready for receiving data as a destination on a display screen and clears said terminal that is not ready for receiving data from said display screen on the basis of said information received by said receiver.

22. The computer program according to claim 19, wherein
said controller displays said terminal that is ready for receiving data and said terminal that is not ready for receiving data in different forms on a display screen, on the basis of said information received by said receiver.

23. The computer program according to claim 22, wherein
when said terminal that is not ready for receiving data is selected as said data send destination by said user, said controller sends data after said terminal becomes ready for receiving data.

24. A computer program for controlling a computer to operate as an apparatus which comprises:
(a) a generator for generating information representing whether or not said apparatus itself is ready for receiving data; and
(b) a sender for sending said information generated by said generator to a terminal via said network at least when said apparatus itself becomes ready for receiving data or becomes no longer ready for receiving data independently of receiving a send request from said terminal.

25. A recording medium on which a computer readable program is recorded, the program controlling said computer to operate as an apparatus which comprises:
(a) a receiver for receiving from a terminal via a network information representing whether or not said terminal is ready for receiving data; and
(b) a limiter for limiting selection of data send destination by a user on the basis of said information received by said receiver.

26. A recording medium on which a computer readable program is recorded, the program controlling said computer to operate as an apparatus which comprises:
(a) a generator for generating information representing whether or not said apparatus itself is ready for receiving data; and
(b) a sender for sending said information generated by said generator to a terminal via said network at least when said apparatus itself becomes ready for receiving data or becomes no longer ready for receiving data independently of receiving a send request from said terminal.
